(19) United States
(12) Patent Application Publication
(10) Pub. No.: US 2005/0237943 A1
(43) Pub. Date: Oct. 27, 2005

(54) Transmission device

(76) Inventor: Yasushi Sasagawa, Kawasaki (JP)

Correspondence Address: KATTEN MUCHIN ROSENMAN LLP, 575 MADISON AVENUE, NEW YORK, NY, 10022-2585, US

(21) Appl. No.: 10/984,303

(22) Filed: Nov. 8, 2004

(30) Foreign Application Priority Data
Apr. 27, 2004 (JP) 2004-131507

(51) Int. Cl. H04L 12/56

(52) U.S. Cl. 370/242

(57) ABSTRACT

A transmission device capable of detecting a fault in communication from any of a root port, alternate port and backup port to a designated port. When the transmission device has designated ports, send request issuing unit thereof issues a send request from the designated ports to an associated transmission device to request same to transmit fault monitoring data. Receiving unit receives fault monitoring data from a root port, alternate port and backup port of the associated transmission device, and detecting unit detects a communication fault based on reception of the fault monitoring data. When the transmission device has a root port, an alternate port and a backup port, transmitting unit thereof transmits fault monitoring data from the root port, the alternate port and the backup port in response to a send request from an associated transmission device.

### CROSS-REFERENCE TO RELATED APPLICATIONS

This application is based upon and claims priority of Japanese Patent Application No. 2004-131507, filed on Apr. 27, 2004, the contents being incorporated herein by reference.

### BACKGROUND OF THE INVENTION

(1) Field of the Invention

The present invention relates to a transmission device, and more particularly, to a transmission device for controlling routing by means of a spanning tree protocol.

(2) Description of the Related Art

Spanning Tree Protocol (hereinafter STP) is a protocol defined in the IEEE 802.1D standard (Media Access Control (MAC) Bridges) and used to configure a single spanning tree (loop-free tree) in a desired bridged LAN (Local Area Network) topology (see, for example, Japanese Unexamined Patent Publication No. 2003-115855 (paragraph nos. [0017] to [0023], FIG. 1) and Japanese Unexamined Patent Publication No. H08-32611 (paragraph nos. [0056] to [0058], FIG. 1)). STP has now been expanded in function by IEEE 802.1s (MSTP: Multiple Spanning Tree Protocol) and IEEE 802.1w (RSTP: Rapid Spanning Tree Protocol) and is widely used in bridged networks.

At first, bridged network was applied mainly to LANs. In recent years, however, the application of bridged network has expanded to carrier networks, as evidenced by the use of the term “wide area Ethernet (registered trademark)”.

In consequence, the functionality required of STP has been expanding and there is an increasing demand for extended functions such as improved fault tolerance, rapid recovery from fault, and configuration of multiple trees (multiple instances) in a single STP network.

To meet such demands, IEEE 802.1w (RSTP) provides an extended function enabling rapid transition of a Point-to-Point link to a Forwarding state, and IEEE 802.1s (MSTP) provides an extended function of configuring multiple trees in a single STP network.

FIG. 22 shows an exemplary configuration of STP-created active topology.

To simplify the explanation, the topology includes only two transmission devices 101 and 111. The transmission devices 101 and 111 are, for example, bridges. The transmission device 101 has ports P101 to P103, and the transmission device 111 has ports P111 to P113.

A terminal 102, which is an end station, is connected locally to the transmission device 101, and a terminal 112, which also is an end station, is connected locally to the transmission device 111. STP is executed with respect to the transmission devices 101 and 111.

It is assumed here that the following conditions are fulfilled: 1. The bridge ID of the transmission device 101 is superior to that of the transmission device 111. 2. In the transmission device 101, the port ID of the port P102 is superior to that of the port P103.

STP is executed under these conditions, whereupon the transmission device 101 is determined as a root bridge. The ports P102 and P103 of the transmission device 101 are selected as Designated Ports (in the figure, indicated by the filled circles) and switched into the Forwarding state.

On the other hand, the port P113 of the transmission device 111 is selected as a Root Port (in the figure, indicated by the empty circle) and switched into the Forwarding state, while the port P112 is selected as an Alternate Port and switched into a Discarding state.

In this manner, the active topology is configured and communication between the terminals 102 and 112 can be performed through the port P102 of the transmission device 101 and the port P113 of the transmission device 111.

With current STP, in a steady state, only the Designated Port periodically transmits a BPDU (Bridge Protocol Data Unit). The Root Port, Alternate Port and Backup port (in FIG. 22, Backup Port is omitted) monitor incoming BPDUs, and if no BPDU is received during a fixed time period, these ports assume the role as Designated Ports and transmit a BPDU to the other transmission device.

Accordingly, a fault in communication from the transmission device 101 to its associated transmission device 111 can be detected. For example, in FIG. 22, a fault in communication from the port P102 of the transmission device 101 to the port P113 of the transmission device 111 can be detected as non-reception of BPDU by the port P113 of the transmission device 111. Also, a fault in communication from the port P103 of the transmission device 101 to the port P112 of the transmission device 111 can be detected as non-reception of BPDU by the port P112 of the transmission device 111.

FIG. 23 shows how the active topology changes when a fault has occurred.

In the figure, identical reference signs are used to denote elements identical with those appearing in FIG. 22 and description of such elements is omitted.

Since the port P112 of the transmission device 111 keeps receiving BPDUs from the port P103 of the transmission device 101, the port P112 takes the role as a Root Port, as shown in FIG. 23. The port P113 of the transmission device 111 fails to receive a BPDU from the port P102 of the transmission device 101 over the fixed time period and thus tries to assume the role as a Designated Port.

The port P102 of the transmission device 101 keeps receiving inferior BPDUs from the P113 of the transmission device 111. As a result, a fault in communication from the port P102 of the transmission device 101 to the port P113 of the transmission device 111 is detected and the port P102 can be switched from the Forwarding state into the Blocking state.

With the port P112 of the transmission device 111 switched into the Forwarding state, the communication between the terminals 102 and 112 is restored through the port P103 of the transmission device 101 and the port P112 of the transmission device 111.

Thus, in the conventional configuration, a fault in communication from the Designated Port to the Root Port, Alternate Port or Backup Port can be detected as non-reception of BPDU by the Root Port, Alternate Port or Backup Port.

However, the conventional transmission device has the problem that a fault in communication from the Root Port, Alternate Port or Backup Port to the Designated Port cannot be detected.

### SUMMARY OF THE INVENTION

The present invention was created in view of the above circumstances, and an object thereof is to provide a transmission device capable of detecting a fault in communication from any of a Root Port, Alternate Port and Backup Port to a Designated Port.

To achieve the object, there is provided a transmission device for controlling routing by means of a spanning tree protocol. The transmission device comprises send request issuing unit for issuing, if the transmission device has designated ports, a send request from the designated ports to an associated device to request same to transmit fault monitoring data, receiving unit for receiving the fault monitoring data from a root port, alternate port and backup port of the associated device with respect to which the send request was issued, detecting unit for detecting a communication fault based on reception of the fault monitoring data, and transmitting unit for transmitting, if the transmission device has the root port, the alternate port and the backup port, the fault monitoring data from the root port, the alternate port and the backup port in response to the send request from an associated device.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram illustrating the principle of a transmission device according to the present invention;

FIG. 2 is a diagram showing an exemplary system configuration including bridges to which the transmission device of the present invention is applied;

FIG. 3 is a functional block diagram of the bridge;

FIG. 4 is a diagram showing the BPDU data format defined in IEEE 802.1w;

FIG. 5 is a diagram showing a detailed data format of Flag appearing in FIG. 4;

FIG. 6 is a diagram showing the data format of a BPDU transmitted from a Root Port, Alternate Port or Backup Port to a Designated Port;

FIG. 7 is a diagram showing a detailed data format of Extension appearing in FIG. 6;

FIG. 8 is a diagram showing a detailed data format of Extension in a BPDU transmitted from the Designated Port to the Root Port, Alternate Port or Backup Port;

FIG. 9 is a sequence diagram illustrating a process performed by the bridge to notify the operator of a communication fault;

FIG. 10 is a sequence diagram illustrating a process performed by the bridge to monitor incoming BPDUs in accordance with the operator's instruction;

FIG. 11 is a sequence diagram illustrating a process performed by the bridges to reconfigure active topology;

FIG. 12 is a diagram summarizing state machines executed by the bridge;

FIG. 13 is a diagram showing statements executed by a PORT TIMERS STATE MACHINE;

FIG. 14 is a diagram showing statements executed by a PORT INFORMATION STATE MACHINE;

FIG. 15 is a diagram showing statements executed by the PORT INFORMATION STATE MACHINE;

FIG. 16 is a diagram showing statements executed by the PORT INFORMATION STATE MACHINE;

FIG. 17 is a diagram showing other statements executed by the PORT INFORMATION STATE MACHINE;

FIG. 18 is a diagram showing other statements executed by the PORT INFORMATION STATE MACHINE;

FIG. 19 is a diagram showing other statements executed by the PORT INFORMATION STATE MACHINE;

FIG. 20 is a diagram showing statements executed by a PORT TRANSMIT STATE MACHINE;

FIG. 21 is a diagram showing statements executed by the PORT TRANSMIT STATE MACHINE;

FIG. 22 is a diagram showing an exemplary configuration of STP-created active topology; and

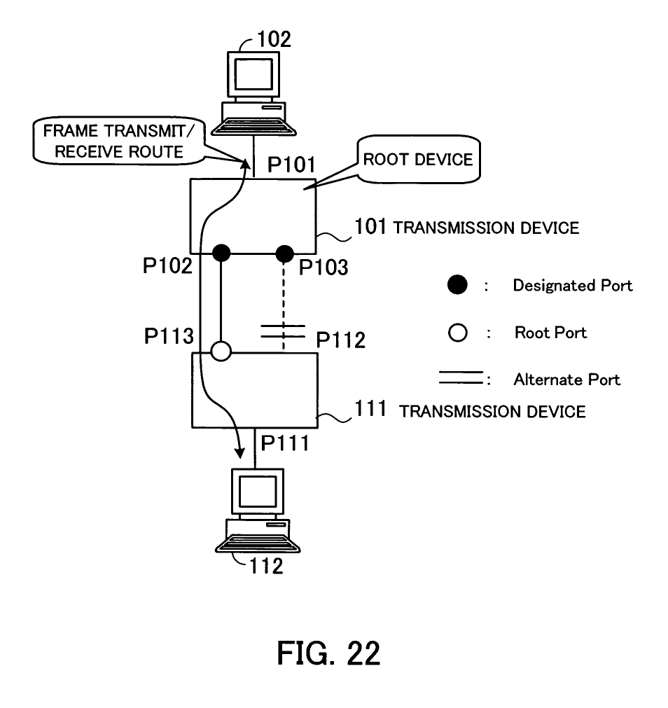

FIG. 23 is a diagram showing how the active topology changes when a fault has occurred.

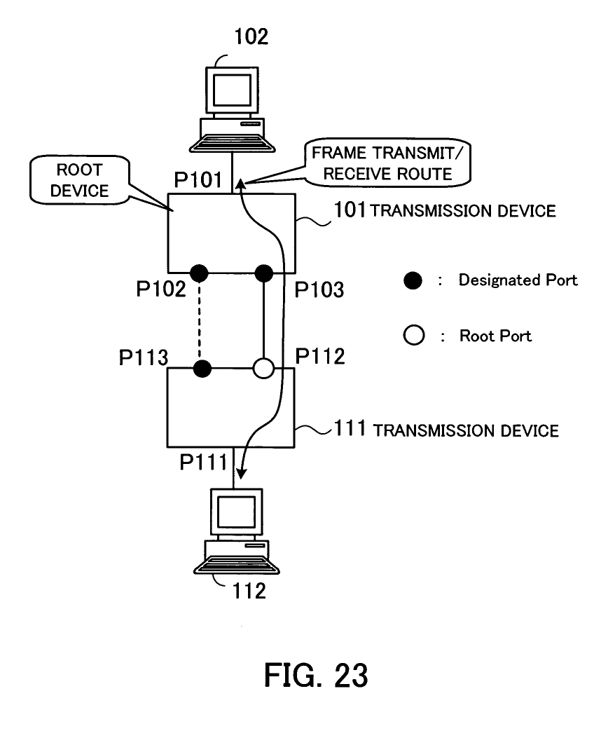

### DESCRIPTION OF THE PREFERRED EMBODIMENTS

The principles of the present invention will be hereinafter described in detail with reference to the drawings.

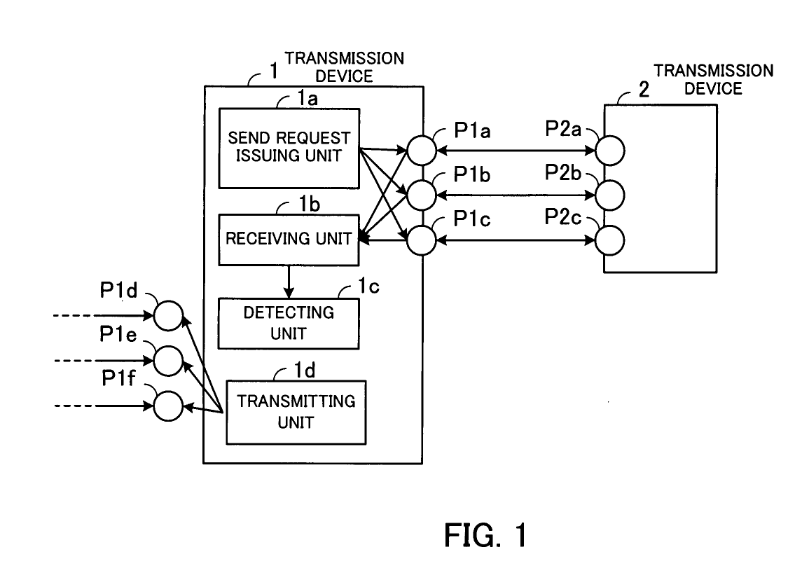

FIG. 1 illustrates the principle of a transmission device according to the present invention.

As shown in the figure, the transmission device 1 comprises send request issuing unit 1a, receiving unit 1b, detecting unit 1c, and transmitting unit 1d.

If the transmission device 1 has Designated Ports P1a, P1b and P1c because of execution of the Spanning Tree Protocol, the send request issuing unit 1a issues a send request from the Designated Ports P1a, P1b and P1c to a transmission device 2 to request same to transmit fault monitoring data.

The receiving unit 1b receives the fault monitoring data from a Root Port P2a, Alternate Port P2b and Backup Port P2c of the transmission device 2 with respect to which the send request was issued.

The detecting unit 1c detects a communication fault on the basis of reception of the fault monitoring data.

If the transmission device 1 has a Root Port P1d, Alternate Port P1e and Backup Port P1f because of execution of the Spanning Tree Protocol, the transmitting unit 1d transmits fault monitoring data from the Root Port P1d, Alternate Port P1e and Backup Port P1f in response to a send request from an associated device, not shown.

Operation in accordance with the principle will be now described.

In the case where because of execution of the Spanning Tree Protocol, the transmission device 1 has Designated Ports P1a, P1b and P1c, the send request issuing unit 1a issues a send request to the transmission device 2, which is an associated device, to request same to transmit fault monitoring data.

The receiving unit 1b receives the fault monitoring data transmitted from the Root Port P2a, Alternate Port P2b and Backup Port P2c of the transmission device 2.

If a fault occurs in communication from the Root Port P2a, Alternate Port P2b or Backup Port P2c of the transmission device 2 to the Designated Port P1a, P1b or P1c of the transmission device 1, the receiving unit 1b cannot receive the fault monitoring data. Accordingly, the detecting unit 1c detects the communication fault as non-reception of the fault monitoring data.

Thus, where the transmission device 1 has Designated Ports P1a, P1b and P1c, a request to send fault monitoring data is issued with respect to the transmission device 2. Then, based on reception of the fault monitoring data from the transmission device 2, a communication fault is detected. Also, in the case where the transmission device 1 has a Root Port P1d, Alternate Port P1e and Backup Port P1f, fault monitoring data is transmitted in response to a send request from an associated transmission device. It is therefore possible to detect faults in communication from the Root Port, Alternate Port and Backup Port to the Designated Ports.

An embodiment of the present invention will be now described in detail with reference to the drawings.

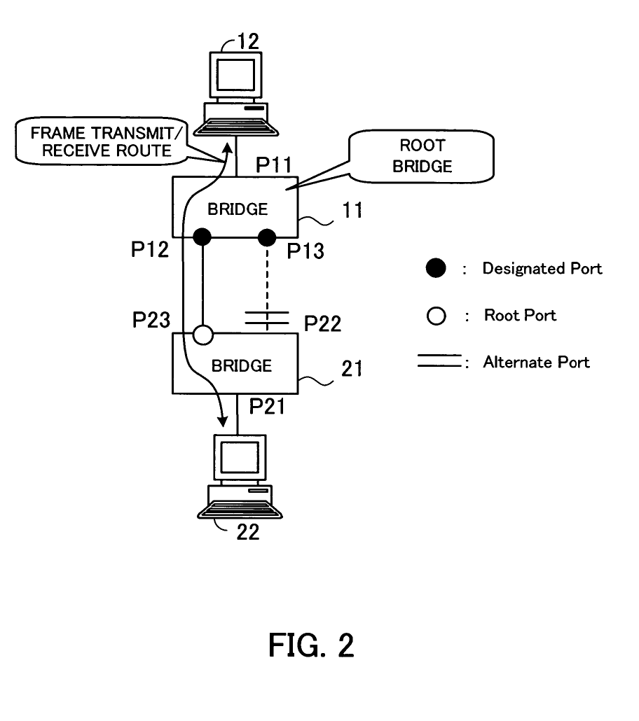

FIG. 2 shows an exemplary system configuration including bridges to which the transmission device of the present invention is applied.

As shown in the figure, the configuration includes bridges 11 and 21 connected to each other. Each bridge may be connected to a plurality of bridges, but for simplicity of explanation, the figure shows only two bridges connected to each other.

The bridge 11 has ports P11 to P13, and the bridge 21 has ports P21 to P23.

A terminal 12, which is an end station, is connected locally to the bridge 11, and a terminal 22, which also is an end station, is connected locally to the bridge 21.

It is assumed here that the following conditions are fulfilled: 1. The bridge ID of the bridge 11 is superior to that of the bridge 21. 2. In the bridge 11, the port ID of the port P12 is superior to that of the port P13.

STP is executed under these conditions, whereupon the bridge 11 is determined as a root bridge. The ports P12 and P13 of the bridge 11 are selected as Designated Ports (in the figure, indicated by the filled circles) and switched into a Forwarding state.

On the other hand, the port P23 of the bridge 21 is selected as a Root Port (in the figure, indicated by the empty circle) and switched into the Forwarding state, while the port P22 is selected as an Alternate Port and switched into a Discarding state.

In this manner, an active topology is configured and communication between the terminals 12 and 22 can be performed through the port P12 of the bridge 11 and the port P23 of the bridge 21.

The ports P12 and P13, which are the Designated Ports of the bridge 11, periodically output a BPDU. Also, a BPDU is output from the ports P23 and P22, which are the Root Port and Alternate Port, respectively, of the bridge 21.

The ports P12 and P13, as the Designated Ports of the bridge 11, monitor BPDUs transmitted from the bridge 21, and if no BPDU is received during a fixed time period, it is judged that a fault has occurred in communication from the bridge 21 to the bridge 11. Also, the ports P23 and P22, as the Root Port and Alternate Port of the bridge 21, monitor BPDUs transmitted from the bridge 11, and if no BPDU is received during the fixed time period, it is judged that a fault has occurred in communication from the bridge 11 to the bridge 21. Such a communication fault includes, for example, a port fault, a link fault and a control software fault.

On detecting a communication fault, the bridges 11 and 21 notify a terminal used by the operator of the occurrence of the fault. The terminal used by the operator is connected to the network to which the bridges 11 and 21 are connected. Alternatively, on detecting a communication fault, the bridges 11 and 21 reconfigure the active topology.

Although not shown in the figure, the bridge 21 has a Backup Port as well.

Functional blocks of the bridge 11 will be now described.

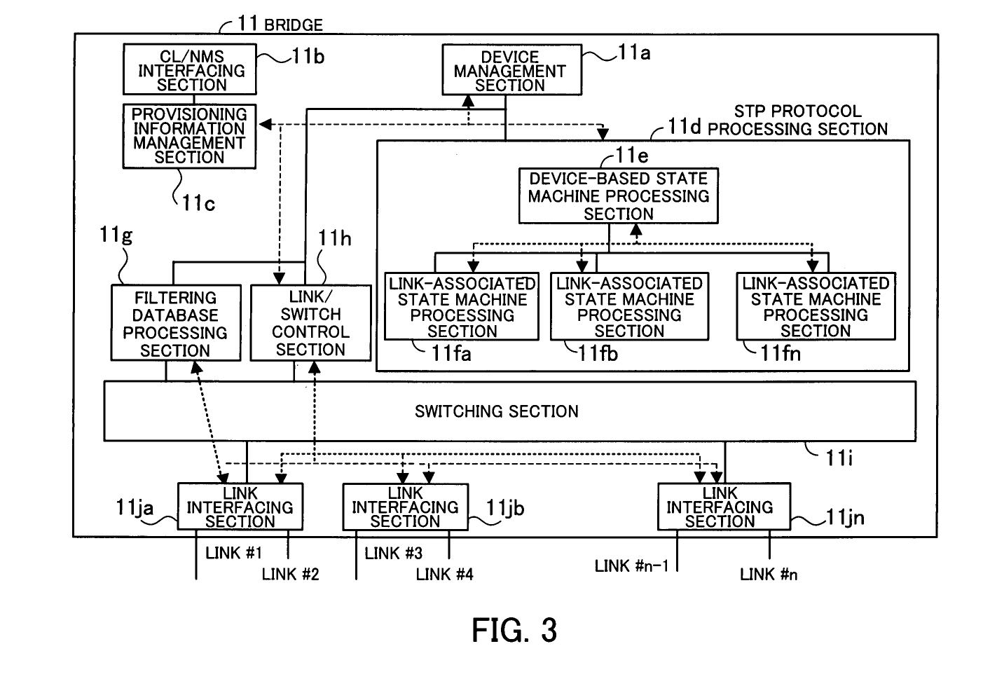

FIG. 3 is a functional block diagram of the bridge.

As shown in the figure, the bridge 11 has a device management section 11a, a CL/NMS interfacing section 11b, a provisioning information management section 11c, an STP protocol processing section 11d, a filtering database processing section 11g, a link/switch control section 11h, a switching section 11i, and link interfacing sections 11ja to 11jn. In the figure, the solid lines each indicate interfacing between the corresponding functional blocks, and the dashed lines each indicate data reference between the corresponding functional blocks.

The device management section 11a takes care of managing the whole bridge. The device management section 11a cooperates with the provisioning information management section 11c to provide the switching section 11i, the link interfacing sections 11ja to 11jn and the STP protocol processing section 11d with instructions about operating conditions, in accordance with provisioning information of the bridge. Also, the device management section 11a acquires, from the switching section 11i, the link interfacing sections 11ja to 11jn and the STP protocol processing section 11d, information about operating states, fault occurrence and recovery from fault, and performs necessary control.

Specifically, in cooperation with the provisioning information management section 11c, the device management section 11a reads out setting information on the variables “adminReverseHello” and “bridgeReverseHello” (described in detail later) and provides the STP protocol processing section 11d with instructions about operating conditions.

When notified of a communication fault from the STP protocol processing section 11d, the device management section 11a notifies the operator of the occurrence of the fault (the notification may be autonomously sent to the operator or may be sent when an inquiry is received from the operator).

Also, when notified of a communication fault from the STP protocol processing section 11d, the device management section 11a instructs the filtering database processing section 11g to flush the filtering database.

Further, when notified of a communication fault from the STP protocol processing section 11d, the device management section 11a instructs the link interfacing sections 11ja to 11jn, via the link/switch control section 11h, to proceed to the “Disable” statement (described in detail later).

The CL/NMS interfacing section 11b administers the interfacing with CL (command line) and NMS (network management system). In cooperation with the provisioning information management section 11c, the CL/NMS interfacing section 11b sets and displays provisioning information.

In accordance with instructions from the CL/NMS interfacing section 11b, the provisioning information management section 11c acquires and outputs the provisioning information and also makes the provisioning information accessible from the individual functional blocks.

The STP protocol processing section 11d plays a principal role in the execution of STP and operates in accordance with the operating conditions instructed from the device management section 11a. Also, on detecting a topology change, the STP protocol processing section 11d notifies the device management section 11a of the topology change. The STP protocol processing section 11d includes a device-based state machine processing section 11e and link-associated state machine processing sections 11fa to 11fn.

The device-based state machine processing section 11e validates/invalidates the communication fault monitoring function in accordance with instructions from the device management section 11a.

When the communication fault monitoring function is valid, the link-associated state machine processing sections 11fa to 11fn perform control such that a BPDU for monitoring a communication fault is transmitted from each of the ports (link interfacing sections 11ja to 11jn) at intervals instructed from the device management section 11a.

Also, when the communication fault monitoring function is valid, the link-associated state machine processing sections 11fa to 11fn transmit BPDUs, in each of which a send request flag is set, to the associated bridge having a Root Port, an Alternate Port and a Backup Port and monitor reception of BPDUs transmitted from that bridge. If reception monitoring timers, which are reset upon reception of a BPDU, indicate time-out, the link-associated state machine processing sections 11fa to 11fn notify the device management section 11a of the time-out.

The filtering database processing section 11g manages MAC filtering databases in cooperation with the provisioning information management section 11c, the device management section 11a and the link interfacing sections 11ja to 11jn. The filtering database processing section 11g provides the individual link interfacing sections 11ja to 11jn with the necessary MAC filtering database and also instructs the link/switch control section 11h to perform the required switching.

In accordance with instructions from the device management section 11a, the link/switch control section 11h notifies the switching section 11i and the link interfacing sections 11ja to 11jn of the operating conditions. Also, the link/switch control section 11h notifies the device management section 11a of information about the operating states, fault occurrence and recovery from fault, received from the switching section 11i and the link interfacing sections 11ja to 11jn.

The switching section 11i performs switching of the individual link interfacing sections 11ja to 11jn in accordance with instructions from the link/switch control section 11h.

The link interfacing sections 11ja to 11jn look up the MAC filtering databases to transmit/receive frames in accordance with instructions from the link/switch control section 11h and the switching section 11i.

The bridge 21 has the same function as the bridge 11 shown in FIG. 3, and therefore, description thereof is omitted.

The data format for BPDUs defined in IEEE 802.1w will be now described.

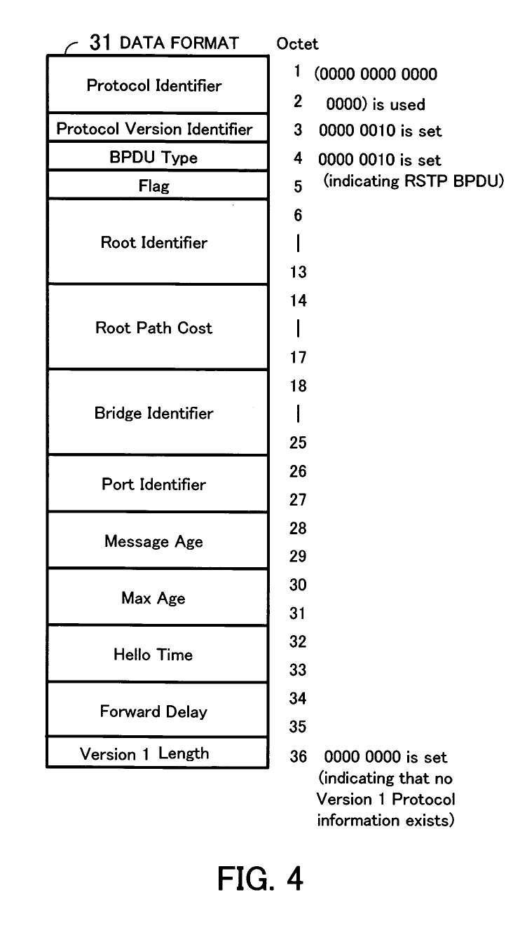

FIG. 4 shows the BPDU data format defined in IEEE 802.1w.

A data format 31 shown in the figure is the BPDU data format defined in IEEE 802.1w. The data format 31 comprises parameters consisting of Protocol Identifier, Protocol Version Identifier, BPDU Type, Flag, Root Identifier, Root Path Cost, Bridge Identifier, Port Identifier, Message Age, Max Age, Hello Time, Forward Delay, and Version 1 Length.

The numbers to the right of the data format 31 indicate the sizes (unit: Octet) of data constituting the respective parameters. For example, Protocol Identifier has a size of 2 Octets.

As shown in the figure, “0” is used for Protocol Identifier, and “10 (binary number)” is set for Protocol Version Identifier. Also, for BPDU Type, “10 (binary number)” is set, which indicates that the BPDU type is RSTP. For Version 1 Length, “0” is set, and for the other parameters, appropriate data for executing RSTP is set.

Flag will be explained in detail.

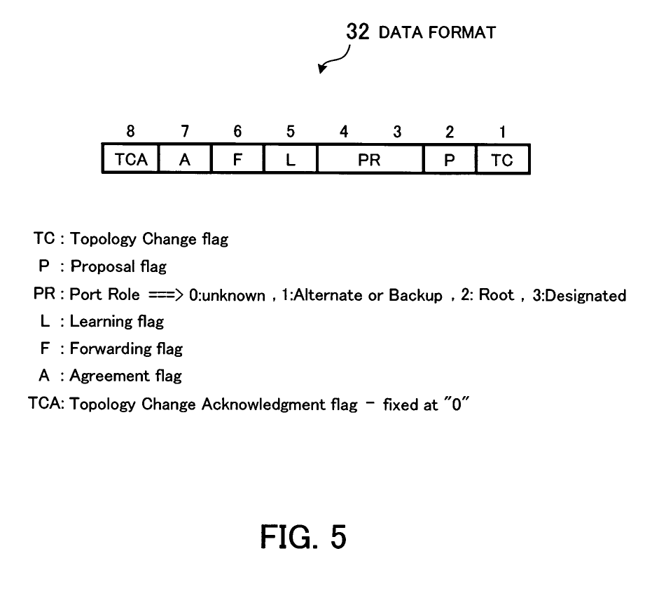

FIG. 5 shows a detailed data format of Flag appearing in FIG. 4.

A data format 32 shown in the figure is the data format of Flag appearing in FIG. 4. The data format 32 comprises TC (Topology Change flag), P (Proposal flag), PR (Port Role), L (Learning flag), F (Forwarding flag), A (Agreement flag), and TCA (Topology Change Acknowledgment flag). In the data format 32, port information for executing RSTP is set, and the port state is set in PR.

Currently, the value of Version 1 Length appearing in FIG. 4 is fixed at “0” and is not in use. The present invention makes use of Version 1 Length to permit detection of a fault in communication from the Root Port, Alternate Port or Backup Port to the Designated Port.

First, the data format of a BPDU transmitted from the Root Port, Alternate Port or Backup Port to the Designated Port will be explained.

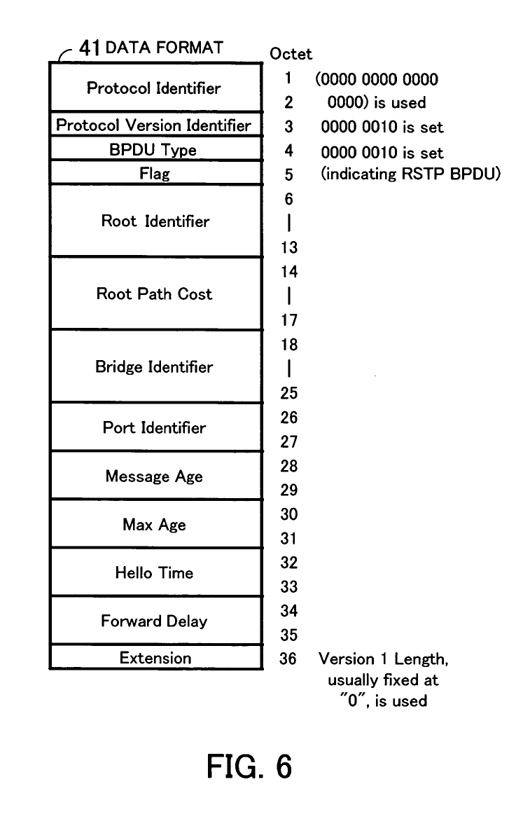

FIG. 6 shows the data format of a BPDU transmitted from the Root Port, Alternate Port or Backup Port to the Designated Port.

A data format 41 shown in the figure is the BPDU data format according to the present invention. The data format 41 comprises parameters consisting of Protocol Identifier, Protocol Version Identifier, BPDU Type, Flag, Root Identifier, Root Path Cost, Bridge Identifier, Port Identifier, Message Age, Max Age, Hello Time, Forward Delay, and Extension. In the data format 41, Version 1 Length of the RSTP BPDU shown in FIG. 4 is used as Extension.

The numbers to the right of the data format 41 indicate the sizes (unit: Octet) of data constituting the respective parameters. For example, Protocol Identifier has a size of 2 Octets.

As shown in the figure, “0” is used for Protocol Identifier, and “10 (binary number)” is set for Protocol Version Identifier. Also, for BPDU Type, “10 (binary number)” is set, which indicates that the BPDU type is RSTP.

Extension will be explained in detail.

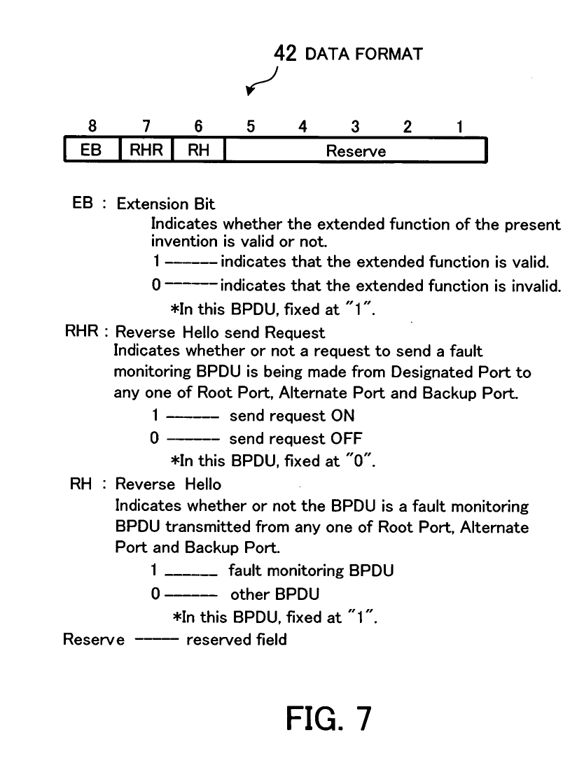

FIG. 7 shows a detailed data format of Extension appearing in FIG. 6.

A data format 42 shown in the figure is the data format of Extension in the data format 41 shown in FIG. 6. The data format 42 comprises EB (Extension Bit), RHR (Reverse Hello send Request), RH (Reverse Hello), and Reserve.

In EB is stored information indicating whether the extended function (detection function) of the present invention is valid or not, where “1” indicates that the extended function is valid and “0” indicates that the extended function is invalid. In RHR is stored information indicating whether or not a request to send a communication fault monitoring BPDU is being made from a Designated Port to any of a Root Port, Alternate Port and Backup Port, where “1” indicates that such a send request is being made and “0” indicates that no such send request is being made. In RH is stored information indicating whether or not the BPDU is a communication fault monitoring BPDU transmitted from any of a Root Port, Alternate Port and Backup Port, where “1” indicates that the BPDU is a communication fault monitoring BPDU and “0” indicates that the BPDU is a BPDU other than the communication fault monitoring BPDU. Since this BPDU is transmitted from any one of a Root Port, Alternate Port and Backup Port to a Designated Port, EB, RHR and RH are fixed at “1”, “0” and “1”, respectively.

The data format of a BPDU transmitted from a Designated Port to a Root Port, Alternate Port or Backup Port will be now described.

A BPDU transmitted from a Designated Port to a Root Port, Alternate Port or Backup Port has a data format identical with the data format 41 shown in FIG. 6. The BPDU transmitted from a Designated Port to a Root Port, Alternate Port or Backup Port differs in Extension settings from the BPDU transmitted from a Root Port, Alternate Port or Backup Port to a Designated Port.

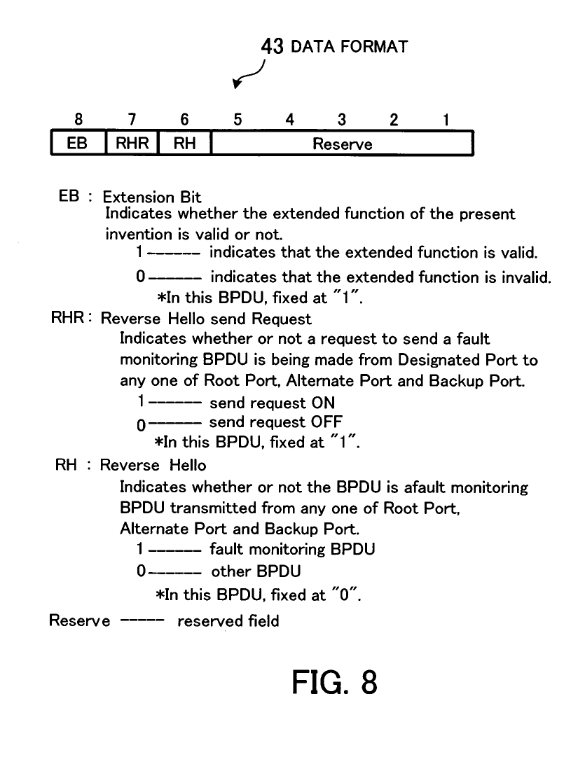

FIG. 8 shows a detailed data format of Extension in the BPDU transmitted from a Designated Port to a Root Port, Alternate Port or Backup Port.

A data format 43 shown in the figure is the data format of Extension in the BPDU and is identical with the data format 42 shown in FIG. 7.

As seen from the illustrated data format 43, EB, RHR and RH in Extension of the BPDU transmitted from a Designated Port to a Root Port, Alternate Port or Backup Port are set to “1”, “1” and “0”, respectively.

When transmitting a BPDU from a Designated Port to any of a Root Port, Alternate Port and Backup Port, the transmission is carried out in the same manner as conventionally known. On the other hand, to transmit a BPDU from any of a Root Port, Alternate Port and Backup Port to a Designated Port in accordance with the present invention, first, a BPDU send request is transmitted from the Designated Port to the Root Port, Alternate Port or Backup Port by using a BPDU with the Extension settings shown in FIG. 8. Thereupon, in response to the send request, the Root Port, Alternate Port or Backup Port transmits a BPDU with the Extension settings shown in FIG. 7 to the Designated Port.

The bridge having a Root Port, an Alternate Port and a Backup Port monitors BPDUs transmitted from the bridge having Designated Ports and thereby monitors communication faults. The bridge having the Designated Ports monitors BPDUs transmitted from the bridge which has the Root Port, Alternate Port and Backup Port and to which the send request was transmitted, thereby monitoring communication faults. It is therefore possible to monitor communication faults in both directions, namely, from the Designated Ports to the Root Port, Alternate Port and Backup Port and vice versa.

In the example explained with reference to FIGS. 6 to 8, Version 1 Length of the BPDU defined in IEEE 802.1w is used to permit a communication fault to be detected in both directions. Alternatively, a 1-byte extension field following Version 1 Length may be provided so that a communication fault can be detected in both directions by using the extension field.

Referring now to sequence diagrams, operations of the bridges 11 and 21 will be explained.

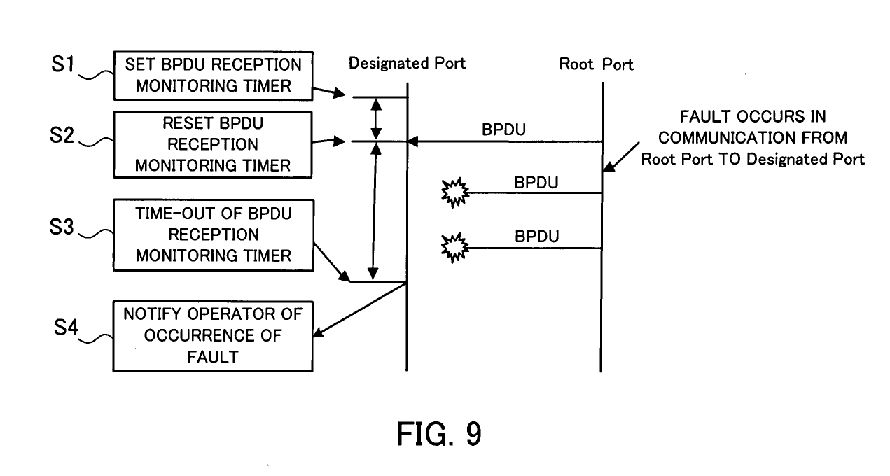

FIG. 9 is a sequence diagram illustrating a process performed by the bridge to notify the operator of a communication fault.

In the figure, “Designated Port” denotes the Designated Port of the bridge 11 as the root bridge, and “Root Port” denotes the Root Port of the bridge 21.

In Step S1, the bridge 11 sets a BPDU reception monitoring timer therein as soon as a port thereof becomes a Designated Port.

Then, in Step S2, the Designated Port of the bridge 11 resets the BPDU reception monitoring timer on receiving a BPDU from the Root Port of the associated bridge 21.

It is assumed here that a fault has occurred in the communication from the Root Port to the Designated Port. Thus, after the occurrence of the communication fault, the Designated Port is unable to receive BPDUs from the Root Port.

Consequently, the BPDU reception monitoring timer of the bridge 11 shows a time-out, in Step S3, since it is not reset.

Because of the time-out of the BPDU reception monitoring timer, the bridge 11 notifies the operator of the communication fault, in Step S4.

On receiving the notification of the communication fault, the operator performs necessary maintenance work depending on the communication fault notified. For example, the operator sets the Designated Port to Disable and makes the STP reconfigure the active topology. Then, the Root Port associated with the Designated Port is changed, and a new Root Port is set to Enable.

In this manner, the Designated Port of the bridge 11 monitors BPDUs, and if the Designated Port fails to receive a BPDU over a fixed time, the notification of communication fault is sent to the terminal used by the operator (such notifying means may specifically be trap or syslog, for example). Also after recovering from this state, the bridge 11 notifies the operator of the recovery. This makes it possible to detect a fault in communication from the Root Port, Alternate Port or Backup Port to the Designated Port, as well as to notify the operator of such a communication fault.

The monitoring of incoming BPDUs may be carried out in accordance with the operator's instruction.

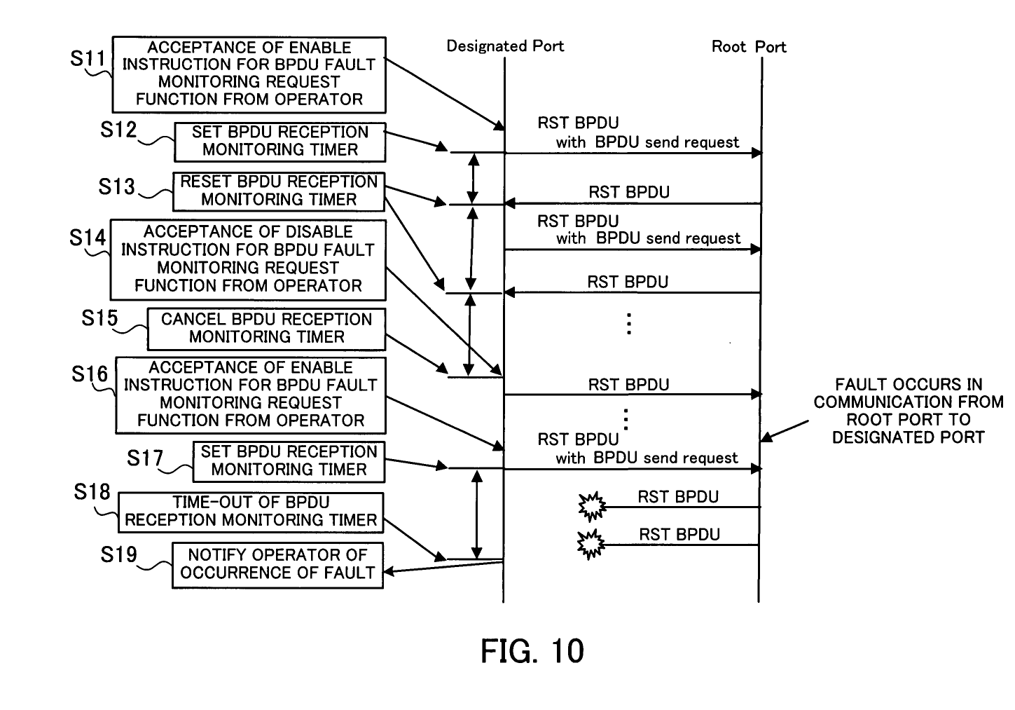

FIG. 10 is a sequence diagram illustrating a process performed by the bridge to monitor incoming BPDUs in accordance with the operator's instruction.

In the figure, “Designated Port” denotes the Designated Port of the bridge 11 as the root bridge, and “Root Port” denotes the Root Port of the bridge 21.

In Step S11, the bridge 11 accepts Enable instruction for a BPDU fault monitoring request function from the operator.

In Step S12, the Designated Port of the bridge 11 transmits a BPDU whose BPDU send request is set ON (“1” is set for RHR in FIG. 8) to the bridge 21, and then sets the BPDU reception monitoring timer.

The BPDU whose BPDU send request is set ON is periodically transmitted until Disable instruction for the BPDU fault monitoring request function is received.

In Step S13, the Designated Port of the bridge 11 resets the BPDU reception monitoring timer on receiving a BPDU from the Root Port of the associated bridge 21.

Let it be assumed that, in Step S14, the bridge 11 receives Disable instruction for the BPDU fault monitoring request function from the operator. The Designated Port of the bridge 11 then stops transmitting the BPDU whose BPDU send request is set ON.

In Step S15, the bridge 11 cancels the BPDU reception monitoring timer. The bridge 11 performs thereafter conventional fault monitoring, that is, it transmits BPDUs to the bridge 21.

Let us suppose that, in Step S16, the bridge 11 again accepts Enable instruction for the BPDU fault monitoring request function from the operator.

Also, let it be assumed that a fault has occurred in the communication from the Root Port to the Designated Port.

In Step S17, the Designated Port of the bridge 11 transmits a BPDU whose BPDU send request is set ON, and also sets the BPDU reception monitoring timer.

Since a fault has occurred in the communication from the Root Port to the Designated Port, the bridge 11 cannot receive a BPDU from the bridge 21.

Consequently, the BPDU reception monitoring timer fails to be reset and thus indicates a time-out, in Step S18.

Because of the time-out of the BPDU reception monitoring timer, the bridge 11 notifies the operator of the communication fault, in Step S19. On receiving the notification of the communication fault, the operator performs necessary maintenance work depending on the fault notified.

In this manner, the reception of BPDUs can be monitored in accordance with the operator's instruction.

After a communication fault is detected, the active topology may be automatically reconfigured by the STP.

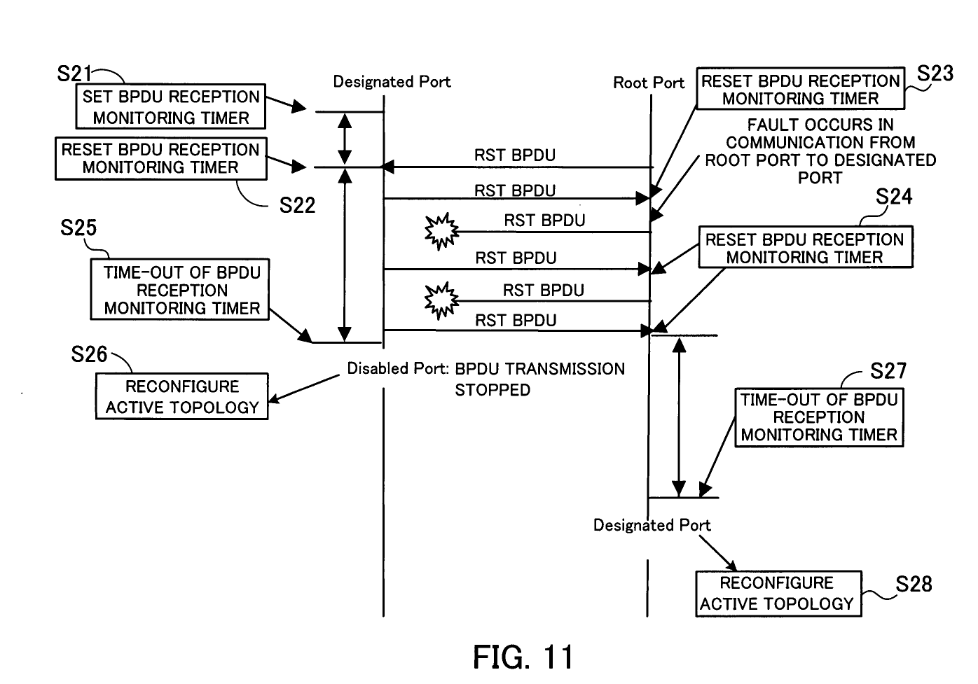

FIG. 11 is a sequence diagram illustrating a process performed by the bridges to reconfigure the active topology.

In the figure, “Designated Port” denotes the Designated Port of the bridge 11 as the root bridge, and “Root Port” denotes the Root Port of the bridge 21. FIG. 11 also illustrates the conventional monitoring of incoming BPDUs by the associated bridge (bridge 21).

In Step S21, the bridge 11 sets the BPDU reception monitoring timer as soon as a port thereof becomes a Designated Port.

In Step S22, the Designated Port of the bridge 11 resets the BPDU reception monitoring timer on receiving a BPDU from the Root Port of the associated bridge 21.

In Step S23, the bridge 21 resets its BPDU reception monitoring timer on receiving a BPDU from the bridge 11.

Let it be assumed that a fault has occurred in the communication from the Root Port to the Designated Port. Consequently, the BPDU transmitted from the bridge 21 does not reach the bridge 11, while the BPDU from the bridge 11 can reach the bridge 21.

In Step S24, the bridge 21 resets the BPDU reception monitoring timer on receiving a BPDU from the bridge 11.

On the other hand, the bridge 11 cannot receive a BPDU because of the fault in communication from the Root Port to the Designated Port.

Accordingly, the BPDU reception monitoring timer of the bridge 11 fails to be reset and indicates a time-out, in Step S25.

In Step S26, in response to the time-out of the BPDU reception monitoring timer, the bridge 11 reconfigures the active topology by means of the STP and causes the Designated Port to switch to a Disabled Port.

On the other hand, the Root Port of the bridge 21 ceases to receive BPDUs because the Designated Port of the bridge 11 has been switched to the Disabled Port, and thus the BPDU reception monitoring timer indicates a time-out, in Step S27.

In Step S28, the bridge 21 reconfigures the active topology by means of the STP.

Thus, the active topology may be automatically reconfigured by means of the STP after a communication fault is detected.

State machines for performing the functions illustrated in FIG. 3 will be now summarized. According to the present invention, some functions of the state machines defined in IEEE 802.1w are modified, with some variables and functions added.

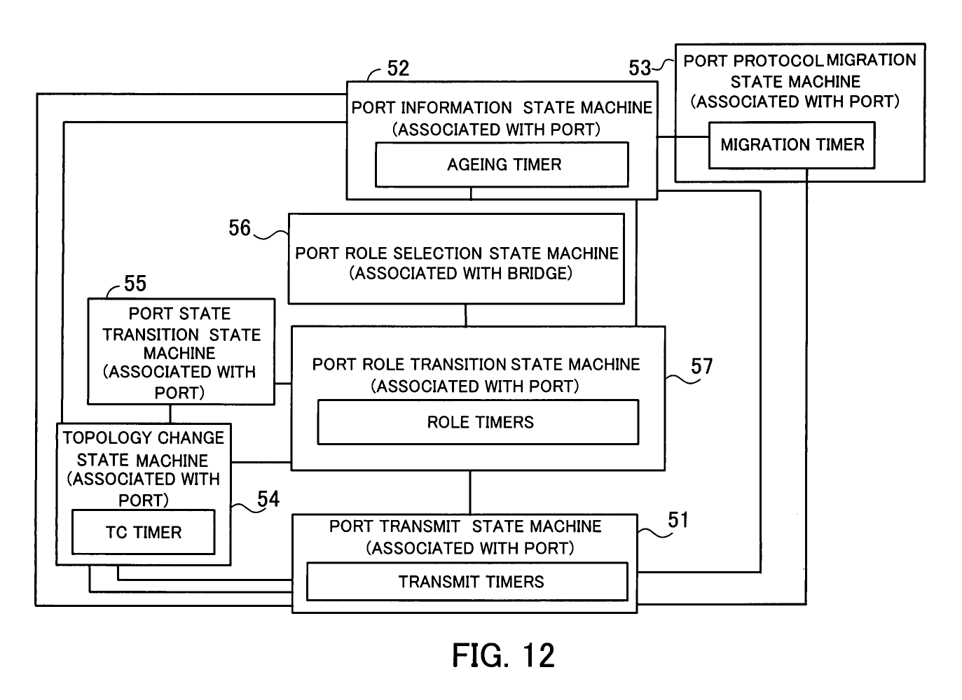

FIG. 12 summarizes state machines executed by the bridge.

A PORT TRANSMIT STATE MACHINE 51 and a PORT INFORMATION STATE MACHINE 52 perform the process of transmitting and receiving BPDUs. Also, these machines interact with other state machines by setting or resetting the flags of variables. For the transmission process, these machines carry out transmission once at a minimum or three times at a maximum within every interval of the Hello Timer and are responsible for the restriction of the transmission rate.

A PORT PROTOCOL MIGRATION STATE MACHINE 53 determines whether to use the BPDU format communicated in a LAN where only RSTP bridges exist or the Configuration BPDU and TCN BPDU format communicated in a LAN where one or more STP bridges exist.

A TOPOLOGY CHANGE STATE MACHINE 54 generates and transfers topology change information.

A PORT STATE TRANSITIONS STATE MACHINE 55 causes the transition of the Root Port and Designated Port to the Forwarding state and also causes the transition of the Alternate Port and Backup Port to the Discarding state.

A PORT ROLE SELECTION STATE MACHINE 56 and a PORT ROLE TRANSITION STATE MACHINE 57 notify the PORT TRANSMIT STATE MACHINE 51, which is associated with each port, of the necessity for the transition to a new Port Role. The PORT ROLE SELECTION STATE MACHINE 56 is provided for every bridge while the other state machines are provided for every port. Although not shown in the figure, a PORT TIMERS STATE MACHINE is executed to decrement the value of a variable every second until the variable becomes equal to “0”.

In the following, statements executed by the state machines will be described in detail. First, variables added in accordance with the present invention will be explained.

The variable “adminReverseHello” is provided on a bridge-by-bridge basis; “TRUE” is set if the operator wishes to validate the fault monitoring function according to the present invention, and “FALSE” is set if the function is to be invalidated. The variable “bridgeReverseHello” is provided on a bridge-by-bridge basis and a BPDU transmission interval is set when the operator validates the fault monitoring function according to the present invention. For this variable, an identical value needs to be set in all of the bridges within the network. The variable “operReverseHello” is provided on a port-by-port basis and “TRUE” is set when “adminReverseHello” is “TRUE”. The variable “reverseHelloWhen” is provided on a port-by-port basis and is used to transmit the fault monitoring BPDU at the set transmission intervals. The variable “rcvdRHWhile” is provided on a port-by-port basis and the value of the BPDU reception monitoring timer is set. The variable “reverseHelloTime” is provided on a port-by-port basis and is equivalent to “bridgeReverseHello”. For “newInfoRH”, “TRUE” is set when the transmission of the fault monitoring BPDU is triggered; otherwise “FALSE” is set. For “rh”, the fault monitoring BPDU receive flag is set, and for “rhWhile” the fault monitoring BPDU send request flag is set.

The following explains functions added or modified according to the present invention.

The function “setRhFlags( )” sets “TRUE” for “rh” if “operReverseHello” is “TRUE” and also if EB, RH and PR of the received BPDU are “1”, “1”, and “1” or “2”, respectively, and otherwise sets “FALSE” for “rh”. The function “setRhWhileFlags( )” sets “TRUE” for “rhWhile” if “operReverseHello” is “TRUE” and also if EB, RHR and PR of the received BPDU are “1”, “1”, and “3”, respectively, and otherwise sets “FALSE” for “rhWhile”. The function “txRstp( )” sets “1” for both of EB and RHR of the BPDU to be transmitted if “operReverseHello” is “TRUE”. The function “txRstprh( )” adds, to “txRstp( )” of IEEE 802.1w, the process of setting “1” for both of EB and RH of the BPDU to be transmitted.

The PORT TIMERS STATE MACHINE will be explained in detail.

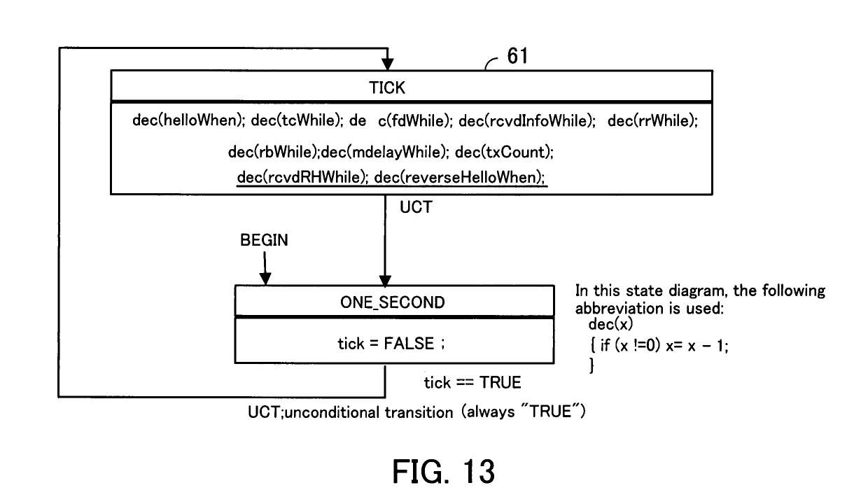

FIG. 13 shows statements executed by the PORT TIMERS STATE MACHINE.

In the figure, the underline indicates the part added according to the present invention. As shown in the figure, the statement TICK 61 is added with “rcvdRHWhile” in which is set the value of the aforementioned BPDU reception monitoring timer, as well as with “reverseHelloWhen” in which is set the fault monitoring BPDU transmission interval. Accordingly, “rcvdRHWhile” and “reverseHelloWhen” are decremented, and due to the interaction with the state machines described later, the reception monitoring and periodic transmission of fault monitoring BPDUs are implemented.

The PORT INFORMATION STATE MACHINE 52 will be now described in detail.

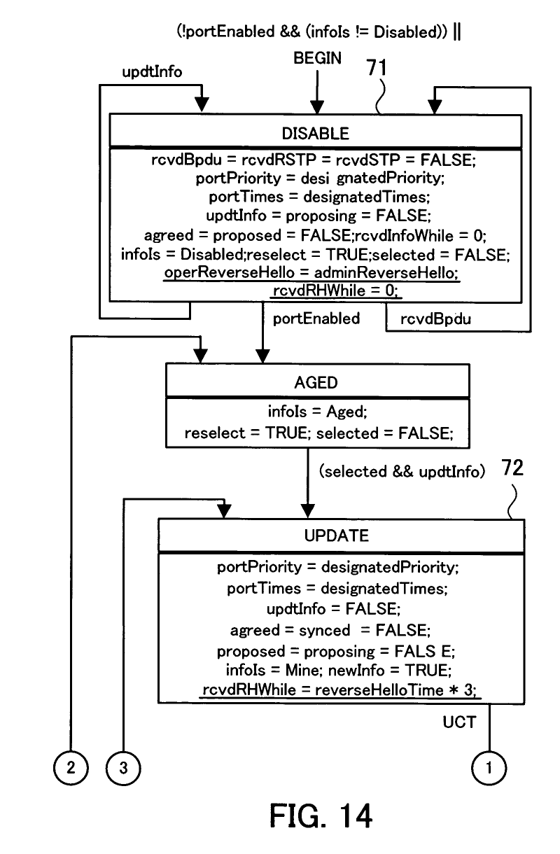

FIGS. 14 to 16 show statements executed by the PORT INFORMATION STATE MACHINE.

In FIGS. 14 to 16, the underlines indicate the parts added according to the present invention. Also, in the figures, the circled numbers indicate the sequence of statements.

The PORT INFORMATION STATE MACHINE 52 interacts with the aforementioned PORT TIMERS STATE MACHINE to monitor the reception of fault monitoring BPDUs and, if a time-out is indicated by the BPDU reception monitoring timer, notifies the operator of a communication fault. Further, the machine 52 detects the fault monitoring BPDU send request and determines, by the interaction with the PORT TRANSMIT STATE MACHINE 51 described in detail later, whether or not the fault monitoring BPDU needs to be transmitted.

In the statement DISABLE 71 shown in FIG. 14, “adminReverseHello” is set for “operReverseHello”. The variable “operReverseHello” is set by the operator and indicates that the transmission of a BPDU from the Root Port is started. For “rcvdRHWhile” in which the value of the BPDU reception monitoring timer is set, “0” is set as an initial value.

In the statement UPDATE 72 shown in FIG. 14, a three-fold value of “reverseHelloTime” is set for “rcvdRHWhile”, thereby setting an allowable reception time for the BPDU to be received from the Root Port. The allowable reception time is used in such a manner that if a BPDU is received within this time, it is judged that there is no communication fault.

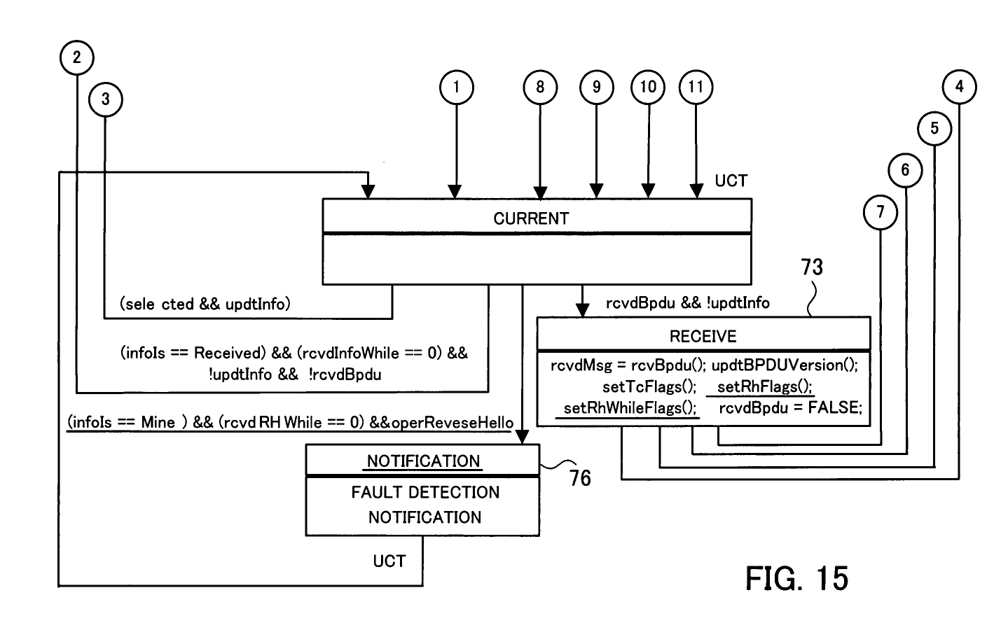

In the statement RECEIVE 73 shown in FIG. 15, the aforementioned “setRhFlags( )” and “setRhWhileFlags( )” are executed. Namely, in RECEIVE 73, the received BPDU is analyzed to determine the use/non-use of the extended function of the present invention, etc., and if the extended function is used, “TRUE” is set for “rh”.

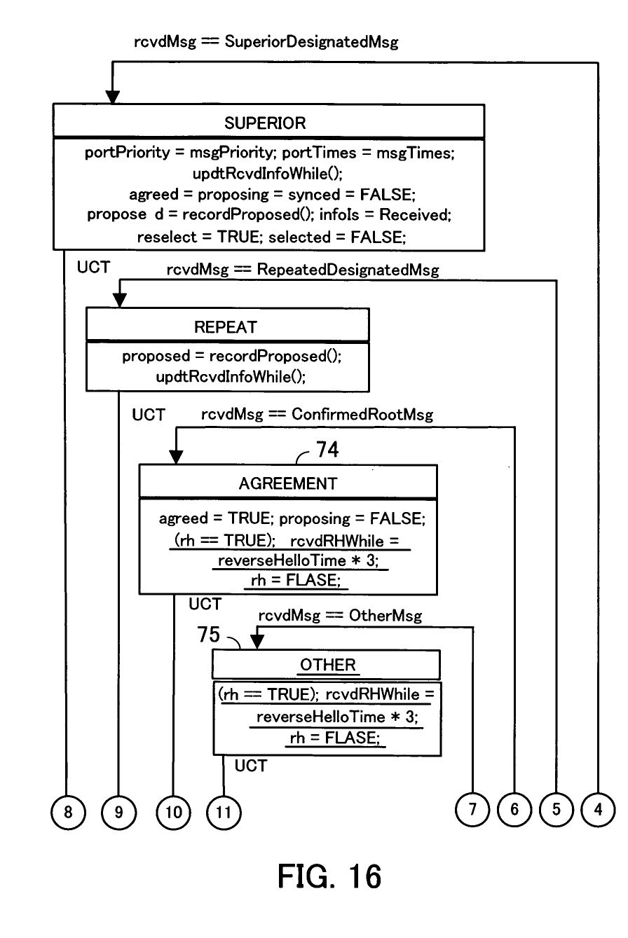

In the statements AGREEMENT 74 and OTHER 75 shown in FIG. 16, it is determined whether “rh” is “TRUE” or “FALSE”. If “rh” is “TRUE”, a three-fold value of “reverseHelloTime” is set for “rcvdRHWhile”, thereby resetting the allowable reception time for the BPDU to be received from the Designated Port or the Root Port. In the figure, SUPERIOR, REPEAT, AGREEMENT 74 or OTHER 75 is conditionally executed in accordance with the type of the message output from RECEIVE 73 shown in FIG. 15.

If “rcvdRHWhile” is “0” as shown in FIG. 15, that is, if the BPDU reception time is up, NOTIFICATION 76 is executed to notify the operator of the occurrence of a fault.

In the above example, when the BPDU reception time is up, the operator is notified of the occurrence of a fault, but the active topology may be recalculated instead.

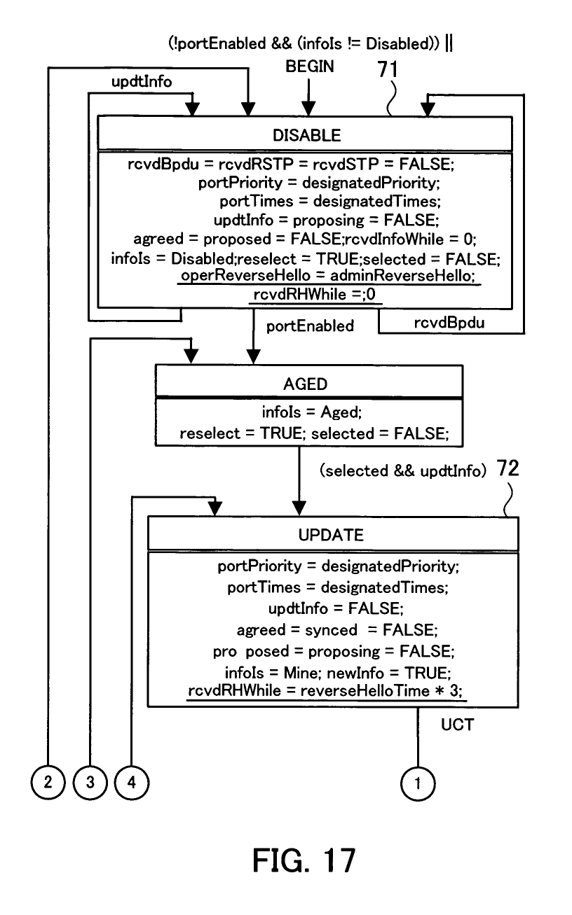

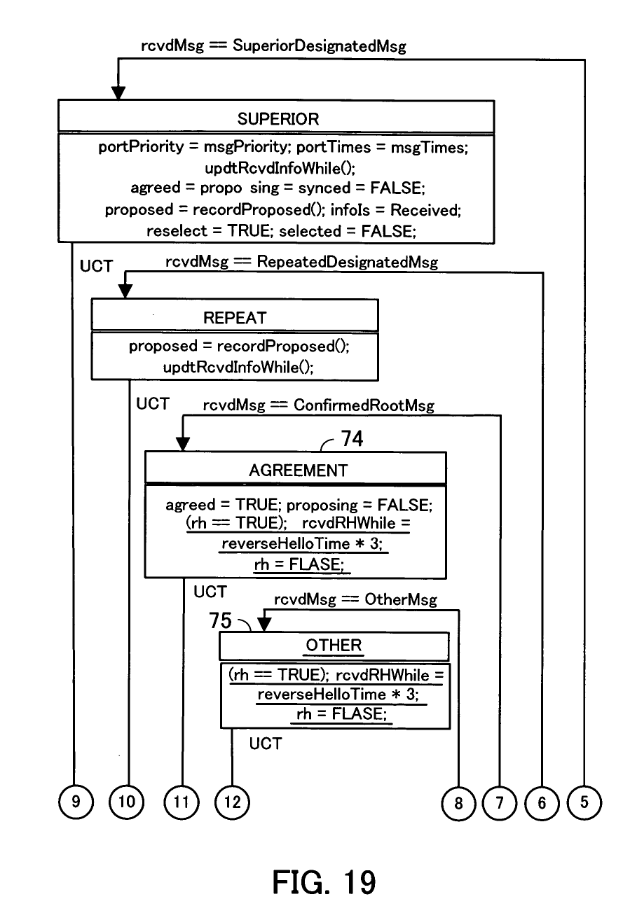

FIGS. 17 to 19 show other exemplary statements executed by the PORT INFORMATION STATE MACHINE.

In FIGS. 17 to 19, identical reference numerals are used to denote statements identical with those shown in FIGS. 14 to 16, and description of such statements is omitted.

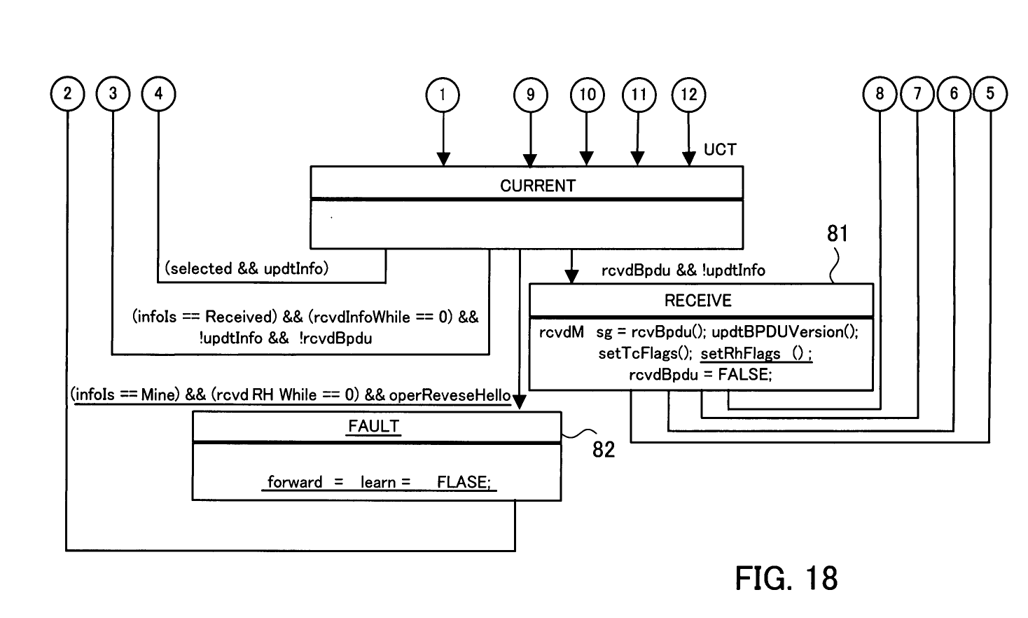

As shown in FIG. 18, in RECEIVE 81, “setRhWhileFlags( )” is not executed and “setRhFlags( )” alone is executed. Also, if “rcvdRHWhile” is “0”, that is, if the BPDU reception time is up, FAULT 82 is executed to set “FALSE” for the variables “forward” and “learn”. The port switches to the Discarding state as soon as “FALSE” is set for the variables “forward” and “learn”.

On completion of the execution of FAULT 82, DISABLE 71 shown in FIG. 17 is executed. As DISABLE 71 and AGED are executed, the active topology is recalculated in the same manner as known in the art.

Thus, when the BPDU reception time is up, the active topology is recalculated.

The PORT TRANSMIT STATE MACHINE 51 will be now described in detail.

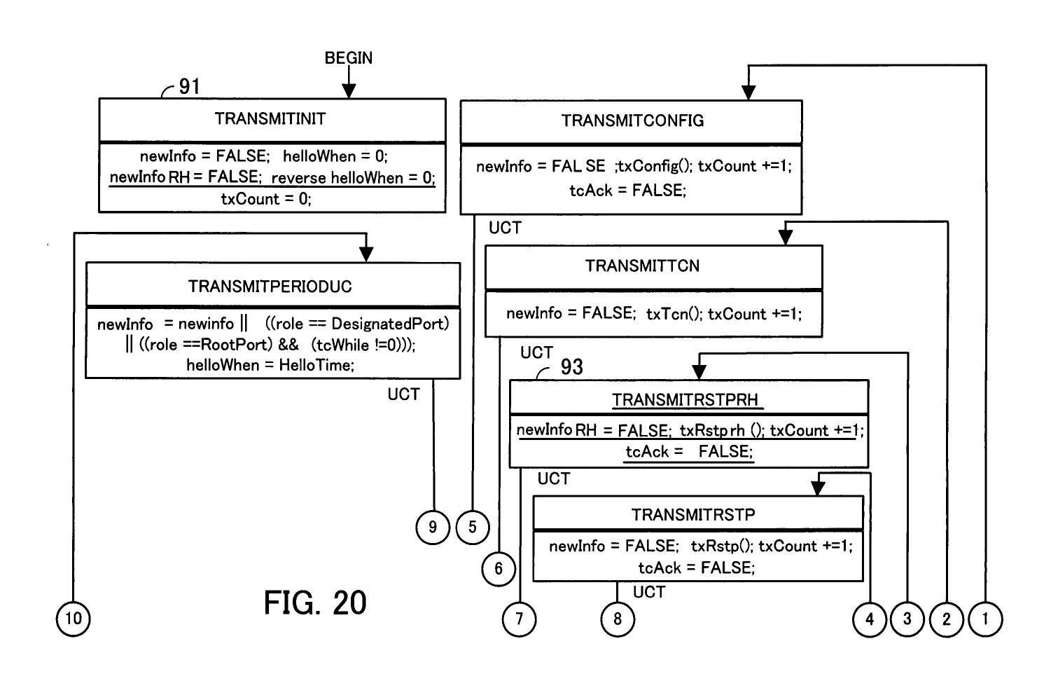

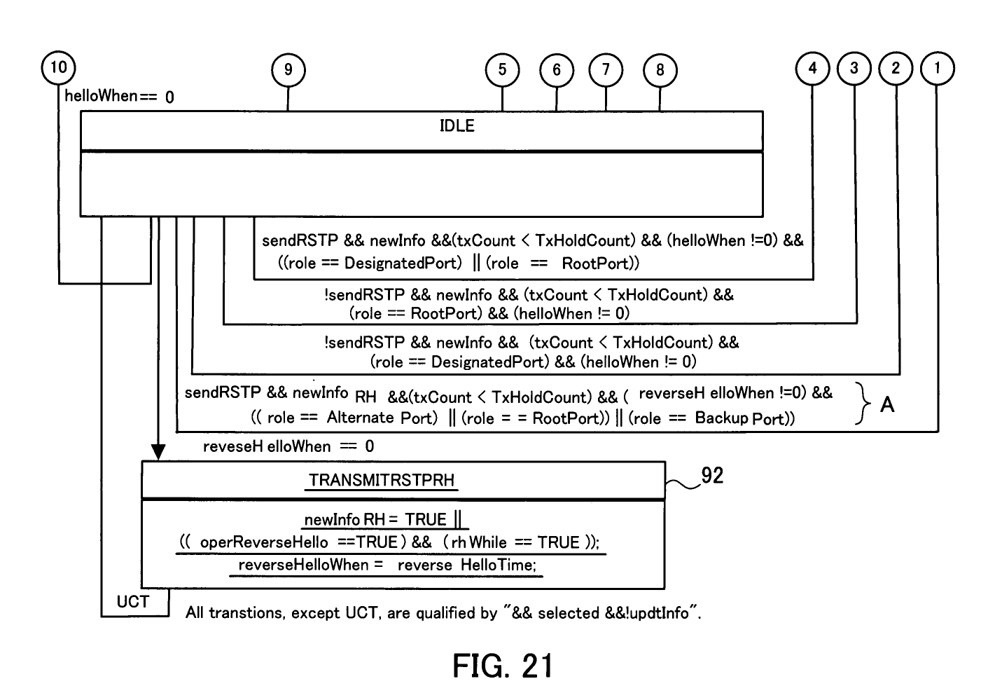

FIGS. 20 and 21 show statements executed by the PORT TRANSMIT STATE MACHINE.

In FIGS. 20 and 21, the underlines indicate the parts added according to the present invention. Also, in the figures, the circled numbers indicate the sequence of statements.

The PORT TRANSMIT STATE MACHINE 51 interacts with the PORT TIMERS STATE MACHINE and the PORT INFORMATION STATE MACHINE 52 to transmit a BPDU including the fault monitoring BPDU send request to the bridge having Designated Ports. Also, when the send request is received, the machine 51 periodically transmits a fault monitoring BPDU.

In the statement TRANSMITINIT 91 shown in FIG. 20, “FALSE” is set for “newInfoRH” and “0” is set for “reverseHelloWhen”.

When “reverseHelloWhen” is “0”, TRANSMITRSTPRH 92 shown in FIG. 21 is executed. In TRANSMITRSTPRH 92, “TRUE” is set for “newInfoRH” and “reverseHelloTime” is set for “reverseHelloWhen”. Namely, the time indicating the BPDU transmission interval is set. On completion of the execution of TRANSMITRSTPRH 92, IDLE is executed, and if the conditions indicated by expression A are fulfilled, TRANSMITRSTPRH 93 shown in FIG. 20 is executed. In TRANSMITRSTPRH 92, “TRUE”was set for “newInfoRH” and a value other than “0” was set for “reverseHelloWhen”, and accordingly, the conditions of expression A are fulfilled if the other conditions are satisfied.

In the statement TRANSMITRSTPRH 93 shown in FIG. 20, “txRstprh( )” is executed, whereby a BPDU is transmitted at the time intervals of “reverseHelloWhen”.

In this manner, BPDUs are transmitted in both directions from the Designated Port to the Root Port, Alternate Port or Backup Port and vice versa, and the reception of the BPDUs is monitored. It is therefore possible to detect also a fault in communication from any of the Root Port, Alternate Port and Backup Port to the Designated Port.

Also, the operator is notified of a communication fault, so that the operator can immediately cope with the communication fault.

It is also possible to recalculate the active topology in response to a fault in communication from the Designated Port to any of the Root Port, Alternate Port and Backup Port and vice versa.

Further, a fault caused in either direction of communication can be easily detected by using an extended version of the BPDU data format defined in IEEE 802.1w.

When the transmission device of the present invention has designated ports, the transmission device issues a send request to an associated device to request same to transmit fault monitoring data, and based on the reception of the fault monitoring data from the associated device, a communication fault is detected. When the transmission device has a root port, alternate port and backup port, the transmission device transmits fault monitoring data in response to the send request from an associated device. This makes it possible to detect a fault in communication from any of the root port, alternate port and backup port to the designated port.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A transmission device for controlling routing by means of a spanning tree protocol, comprising:
send request issuing unit for issuing, if said transmission device has designated ports, a send request from the designated ports to an associated device to request same to transmit fault monitoring data;
receiving unit for receiving the fault monitoring data from a root port, alternate port and backup port of the associated device with respect to which the send request was issued;
detecting unit for detecting a communication fault based on reception of the fault monitoring data; and
transmitting unit for transmitting, if said transmission device has the root port, the alternate port and the backup port, the fault monitoring data from the root port, the alternate port and the backup port in response to the send request from an associated device.

2. The transmission device according to claim 1, wherein said detecting unit detects occurrence of the communication fault if the fault monitoring data is not received during a fixed time.

3. The transmission device according to claim 1, further comprising notifying unit for notifying a terminal used by an operator of the detection of the communication fault.

4. The transmission device according to claim 1, further comprising reconfiguring unit for reconfiguring active topology when the communication fault is detected.

5. The transmission device according to claim 1, wherein the fault monitoring data is an extended version of a bridge protocol data unit defined in IEEE 802.1w.

6. The transmission device according to claim 1, wherein the communication fault detection is validated and invalidated in accordance with an operator's instruction.

7. The transmission device according to claim 6, wherein the fault monitoring data has areas for storing information on the send request, information on the validity and information on the invalidity and is communicated with the associated device.

8. The transmission device according to claim 6, wherein the operator's instruction is accepted when said transmission device has the designated ports.

9. The transmission device according to claim 8, wherein the fault monitoring data has areas for storing information on the send request, information on the validity and information on the invalidity and is communicated with the associated device.

10. A communication fault detection program for a transmission device which controls routing by means of a spanning tree protocol,
wherein said communication fault detection program causes a computer to function as:
send request issuing unit for issuing, if the transmission device has designated ports, a send request from the designated ports to an associated device to request same to transmit fault monitoring data;
receiving unit for receiving the fault monitoring data from a root port, alternate port and backup port of the associated device with respect to which the send request was issued;
detecting unit for detecting a communication fault based on reception of the fault monitoring data; and
transmitting unit for transmitting, if the transmission device has the root port, the alternate port and the backup port, the fault monitoring data from the root port, the alternate port and the backup port in response to the send request from an associated device.
